(19) United States
(12) Patent Application Publication
(10) Pub. No.: US 2015/0209204 A1
(43) Pub. Date: Jul. 30, 2015

(54) INTELLIGENT WALKER

(71) Applicant: YUAN ZE UNIVERSITY, TAOYUAN COUNTY (TW)

(72) Inventors: YEH-LIANG HSU, TAOYUAN COUNTY (TW); YU-WEI LIU, NEW TAIPEI CITY (TW); KE-YUAN WU, TAOYUAN COUNTY (TW); TZA-WEI CHEN, TAINAN CITY (TW)

(21) Appl. No.: 14/495,585

(22) Filed: Sep. 24, 2014

(30) Foreign Application Priority Data
Jan. 29, 2014 (TW) 103103497

(51) Int. Cl. A61G 5/04; A61G 5/10

(52) U.S. Cl. CPC A61G 5/04; A61G 5/101; A61G 5/1037; A61G 2005/048; A61G 2005/1051; A61G 2203/16; A61G 2203/34

(57) ABSTRACT

An intelligent walker includes a holder, a support frame, a sensing grip, a driving device, and a control device. The support frame is configured for supporting the holder. The bottom side of the support frame is disposed with a plurality of wheels. The driving device is configured for driving the wheels so as to move the intelligent walker. The sensing grip is disposed behind the holder and has a pressure-sensing element. The pressure-sensing element is configured for sensing the magnitude of a force of a user's hands and a position of the user's hands on the sensing grip and for generating a sensing signal. The control device is connected to the pressure-sensing element and the driving device, and configured for receiving the sensing signal and generating a control signal. The driving device receives the control signal and correspondingly changes the movement speed and direction of the intelligent walker.

### BACKGROUND

1. Technical Field

The present disclosure relates to an intelligent walker, in particular, to an intelligent walker with a sensing grip.

2. Description of Related Art

With the advent of an aging society, the population of elderly disabled people in many countries is increasing quickly. For elderly disabled people, it is important to have a wheelchair that keeps up with them and meets their demands. However, for elderly people with disabled upper limbs, the manual wheelchair is not convenient because they cannot move the manual wheelchair by themselves. In addition, for a family caregiver, a lot of energy is needed to move the manual wheelchair when the family caregiver passes through an uphill or rugged road.

Therefore, compared to the manual wheelchair, the electric wheelchair is a better choice for outdoor use. It is worth noting that there are still some difficulties in operation of the electric wheelchair. More specifically, a controller for controlling the operation of a traditional electric wheelchair is commonly disposed on two sides of the grip of the traditional electric wheelchair, so that the family caregiver can conveniently operate it. However, due to the fact that the position of the controller on the grip is fixed, it may be not appropriate for different family caregivers to operate. Moreover, the controller is commonly a switch knob, and a switch knob is not convenient for the family caregiver to operate to change the speed of the traditional electric wheelchair when the traditional electric wheelchair is moving. In addition, the traditional electric wheelchair only moves at a predetermined speed previously set by the family caregiver through the switch knob, so the movement speed of the traditional electric wheelchair cannot be changed by the family caregiver anytime and anywhere. Therefore, the operation interface (e.g. controller) of the traditional manual wheelchair or electric wheelchair may not provide simple design and straightforward operation for the family caregiver.

### SUMMARY

An exemplary embodiment of the present disclosure provides an intelligent walker with a sensing grip. The intelligent walker is turned on/off or moves faster/slower according to the force the user uses and the position of the user's hands on the sensing grip.

An exemplary embodiment of the present disclosure provides an intelligent walker that includes a holder, a support frame, a sensing grip, a driving device, and a control device. The support frame is configured for supporting the holder, and the bottom side of the support frame is disposed with a plurality of wheels. The driving device is configured for driving the wheels so as to move the intelligent walker. The sensing grip is disposed behind the holder and has a pressure-sensing element. The pressure-sensing element is configured for sensing a force put on the pressure-sensing element by a user's hands and a position of the user's hands on the pressure-sensing element so as to generate a sensing signal. The control device is connected to the pressure-sensing element and the driving device, and the control device is configured for receiving the sensing signal and generating a control signal. The control signal is transmitted to the driving device, and the driving device drives the wheels according to the received control signal so as to change the movement speed and movement direction of the intelligent walker.

In summary, exemplary embodiments of the present disclosure provide an intelligent walker with the sensing grip. The pressure-sensing element of the sensing grip is used for sensing the force of the user's hands and the position of the user's hands on the sensing grip, so that the control device can immediately and correspondingly turn on/off the intelligent walker or change the movement speed and movement direction of the intelligent walker according to the received sensing signal transmitted by the pressure-sensing element. Accordingly, operation of the intelligent walker is quite straightforward for the user. The user can immediately regulate the movement speed and movement direction of the intelligent walker by changing the magnitude of the force put on the sensing grip in response to different environments.

In order to further understand the techniques, means and effects of the present disclosure, the following detailed descriptions and appended drawings are hereby referred to, such that, and through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1A is a schematic diagram of an intelligent walker in accordance with an exemplary embodiment of the present disclosure.

FIG. 1B is a block diagram of the intelligent walker in accordance with an exemplary embodiment of the present disclosure.

FIG. 2A is a schematic diagram illustrating a user holding a first indicated region of a sensing grip in accordance with an embodiment of the present disclosure.

FIG. 2B is a schematic diagram illustrating a user holding a second indicated region of the sensing grip in accordance with another embodiment of the present disclosure.

FIG. 2C is a schematic diagram of a sensing grip in accordance with another exemplary embodiment of the present disclosure.

FIG. 2D is a schematic diagram of a sensing grip in accordance with another exemplary embodiment of the present disclosure.

FIG. 2E is a schematic diagram of a pressure-sensing element being unloaded in accordance with an exemplary embodiment of the present disclosure.

FIG. 3 is a schematic diagram of an intelligent walker in accordance with another exemplary embodiment of the present disclosure.

### DESCRIPTION OF THE EXEMPLARY EMBODIMENTS

The aforementioned illustrations and following detailed descriptions are exemplary for the purpose of further explaining the scope of the instant disclosure. Other objectives and advantages related to the instant disclosure will be illustrated in the subsequent descriptions and appended drawings.

It should be understood that the usage of “first”, “second” and “third” intends to distinguish one element from another, and the element should not be limited by the term. Therefore, hereinafter a first element is interchangeable with a second element. The term “and/or” includes one and one or more of the combination in the group as described.

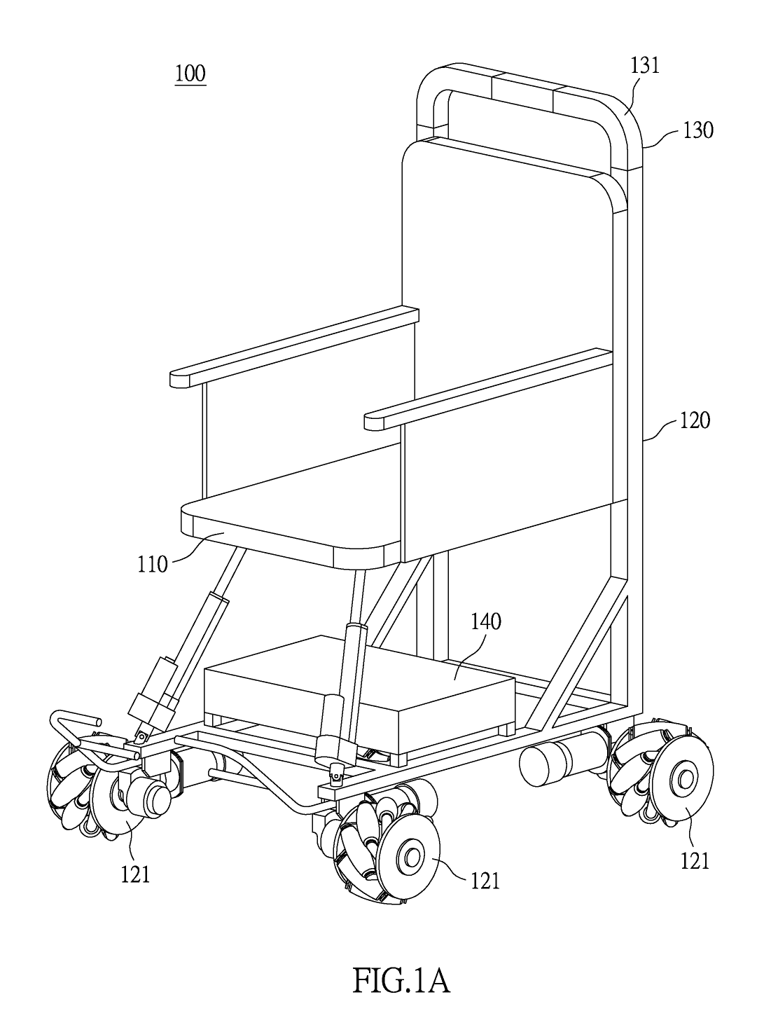

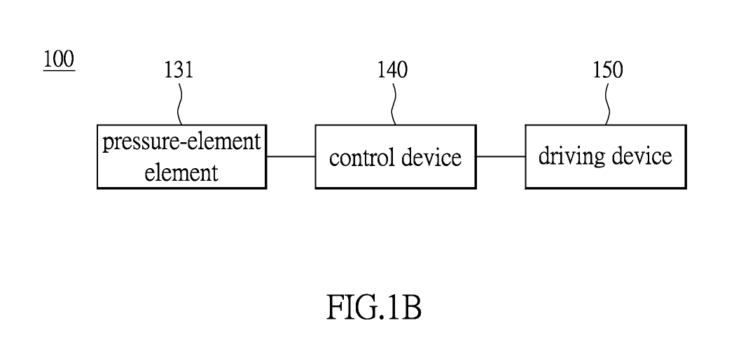

Please refer to FIG. 1A and FIG. 1B. FIG. 1A shows a schematic diagram of an intelligent walker in accordance with an exemplary embodiment of the present disclosure. FIG. 1B shows a block diagram of the intelligent walker in accordance with an exemplary embodiment of the present disclosure. The intelligent walker 100 includes a holder 110, a support frame 120, a sensing grip 130, a control device 140, and a driving device 150. As shown in FIG. 1A, the support frame 120 is configured for supporting the holder 110, and the bottom side of the support frame 120 is disposed with a plurality of wheels 121. The sensing grip 130 is disposed behind the holder 110 and with a pressure-sensing element 131 in order to form a pressure-sensing region, wherein the pressure-sensing element 131 is used for sensing a force of a user's hands and the position of the user's hands on the pressure-sensing element 131 so as to generate a sensing signal. As shown in FIG. 1B, the control device 140 is electrically connected to the pressure-sensing element 131 and the driving device 150. The driving device 150 is disposed near the wheels 121, and the driving device 150 is configured for driving the wheels 121 so as to cause the movement of the intelligent walker 100. The control device 140 is configured for receiving the sensing signal from the pressure-sensing element 131 and controlling the driving device 150 to drive the wheels 121 according to the received sensing signal. Therefore, the movement speed and movement direction of the intelligent walker 100 can be correspondingly changed according to the received sensing signal.

In the instant embodiment, the holder 110 may be a seat for an elderly, a disabled people, or even any person to sit on. The holder 110 may be configured depend upon the practical operation needs of the person sitting on it, and the instant embodiment is not limited thereto. The pressure-sensing element 131 may be a soft pressure sensor, composed of elastic fabric and conductive fiber material, wherein the conductive fiber material is sewed on the elastic fabric to form a plurality of flexible electric contact points. More specifically, when there is a force or pressure put on the pressure-sensing element 131, the resistance of the conductive fiber material is correspondingly changed (i.e. when the force per unit area becomes greater, the value of the resistance becomes smaller). In other words, the resistance of pressure-sensing element 131 is correspondingly changed when a force put on the pressure-sensing element 131 is changed. Therefore, the pressure-sensing element 131 can correspondingly generate the sensing signal according to the magnitude of the force put on the pressure-sensing element 131 by a user's hands and the position of the user's hands on the pressure-sensing element 131. The control device 140 may be disposed with a microcontroller, configured for processing the sensing signal from the pressure-sensing element 131, wherein the microcontroller is programmed with the code for processing the sensing signal through firmware design. More specifically, by executing the code programmed in the microcontroller, the control device 140 processes the received sensing signal and determines the magnitude of the force of a user's hands and the position of the user's hands on the pressure-sensing element 131. Correspondingly, the control device 140 generates a first control signal and transmits the first control signal to the driving device 150. The driving device 150 may be disposed with a plurality of motors (not shown). The motors are disposed near the wheels 121 and configured for driving the wheels 121, wherein the wheels 121 may be implemented by a plurality of mecanum wheels. More specifically, according to the received first control signal, the driving device 150 correspondingly drives the motors so as to cause the movement of the intelligent walker 100 in a specified operation mode.

It is worth noting that the pressure-sensing element 131 may be implemented by other flexible pressure sensors, such as a commercially available flexiforce sensor. The wheels 121 may be implemented by common wheels or a rocker-bogie system. The rocker-bogie system allows for better maneuverability on a rough road. The exact number and type of the wheels 121 and the motor may be configured depending upon the practical operation needs, and the instant embodiment is not limited thereto.

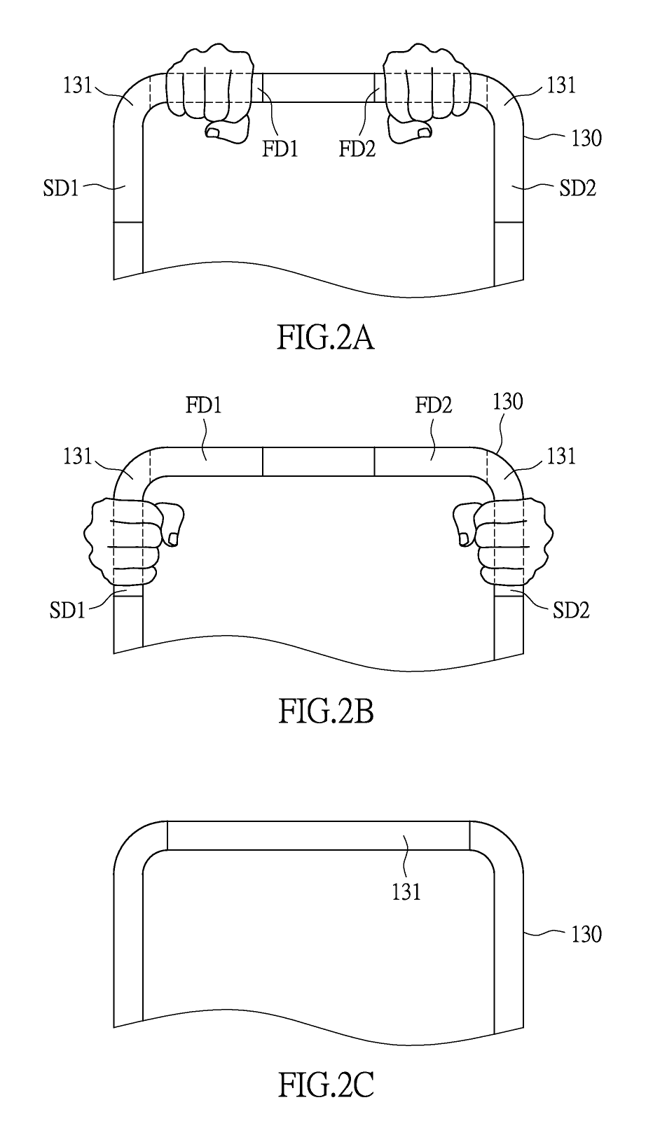

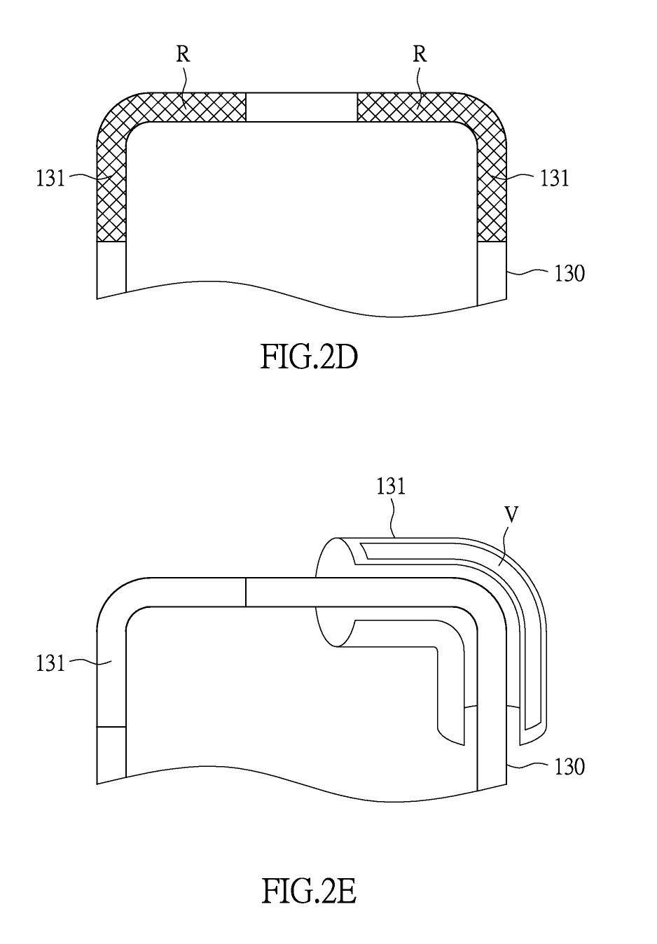

Please refer to FIG. 1A, FIG. 2A and FIG. 2B. FIG. 2A shows a schematic diagram illustrating a user holding a first indicated region of a sensing grip in accordance with an embodiment of the present disclosure. FIG. 2B shows a schematic diagram illustrating a user holding a second indicated region of the sensing grip in accordance with another embodiment of the present disclosure. In the instant embodiment, the pressure-sensing element 131 is two independent components, and the components are respectively disposed on two sides of the sensing grip 130 as shown in the FIG. 2A and FIG. 2B. As shown in FIG. 2A, when the user's hands hold a first indicated region (e.g. areas FD1 and FD2) of the pressure-sensing element 131 (e.g. near the central position of the sensing grip 130), the pressure-sensing element 131 correspondingly generates a first sensing signal. The first sensing signal is transmitted to the control device 140 of the intelligent walker 100 through a data transmission line (not shown) which is connected between the pressure-sensing element 131 and the control device 140, or the first sensing signal is transmitted to the control device 140 through a wireless transmission device (not shown). The control device 140 processes the received first sensing signal and generates the first control signal, wherein the first control signal may be regarded as a direction control signal for having the intelligent walker 100 move forwards. The first control signal is transmitted to the driving device 150, so that the driving device 150 drives the wheels 121 to move forwards according to the received first control signal.

On the other hand, as shown in the FIG. 2B, when the user's hands hold a second indicated region (e.g. areas SD1 and SD2) of the pressure-sensing element 131 (e.g. near two sides of the sensing grip 130), the pressure-sensing element 131 correspondingly generates a second sensing signal. The second sensing signal is transmitted to the control device 140 of the intelligent walker 100 through the aforementioned components. The control device 140 processes the received second sensing signal and generates the second control signal, wherein the second control signal may be regarded as a direction control signal for having the intelligent walker 100 move backwards. The second control signal is transmitted to the driving device 150, so that the driving device 150 drives the wheels 121 to move backwards according to the received second control signal.

It is worth noting that the definition of the first and second indicated regions hold by the user for driving the intelligent walker 100 to move backwards or forwards may be configured depending upon practical operation needs, and the present disclosure is not limited thereto.

In short, the user can straightforwardly control the intelligent walker 100 to move forwards or backwards by holding the first indicated region (e.g. areas FD1 and FD2) and the second indicated region (e.g. areas SD1 and SD2). Accordingly, the user doesn't need to previously set the movement direction of the intelligent walker 100 through a traditional operation interface.

Moreover, when the user's hands hold the first indicated region (e.g. areas FD1 and FD2) or the second indicated region (e.g. areas SD1 and SD2) of the sensing grip 130 for driving the intelligent walker 100 to move backwards or forwards and the magnitude of the force put on the pressure-sensing element 131 tends towards being larger, the control device 140 correspondingly receives a third sensing signal from the pressure-sensing element 131. The control device 140 processes the received third sensing signal and generates the third control signal, wherein the third control signal may be regarded as a speed control signal for having the intelligent walker 100 move faster. The third control signal is transmitted to the driving device 150. The driving device 150 drives the wheels 121 to rotate faster according to the received third control signal, so that the movement speed of the intelligent walker 100 correspondingly becomes faster.

On the other hand, when the user's hands hold the first indicated region (e.g. areas FD1 and FD2) or the second indicated region (e.g. areas SD1 and SD2) of the sensing grip 130 for driving the intelligent walker 100 to move backwards or forwards and the magnitude of the force put on the pressure-sensing element 131 tends towards being smaller, the control device 140 correspondingly receives a fourth sensing signal from the pressure-sensing element 131. The control device 140 processes the received fourth sensing signal and generates the fourth control signal, wherein the fourth control signal may be regarded as a speed control signal for having the intelligent walker 100 move slower. The fourth control signal is transmitted to the driving device 150. The driving device 150 drives the wheels 121 to rotate slower according to the received fourth control signal, so that the movement speed of the intelligent walker 100 correspondingly becomes slower.

In the instant embodiment, when the magnitude of the force put on the pressure-sensing element 131 by the user tends towards being larger, the control device 140 generates the corresponding control signal for making the intelligent walker 100 move slower. On the other hand, when the magnitude of the force put on the pressure-sensing element 131 by the user tends towards being smaller, the control device 140 generates the corresponding control signal for making the intelligent walker 100 move faster. The implementation and operation of the intelligent walker 100 and the present disclosure is not limited thereto.

In short, the user can straightforwardly control the intelligent walker 100 to move quickly or slowly by changing the magnitude of the force put on the pressure-sensing element 131. Accordingly, the user doesn't need to previously set the movement speed of the intelligent walker 100 through a traditional operation interface. The user can immediately regulate the movement speed of the intelligent walker based on different environments.

In addition, when the force put on the pressure-sensing element 131 by the user's left hand is greater than the force put on the pressure-sensing element 131 by the user's right hand, the control device 140 receives a fifth sensing signal from the pressure-sensing element 131 and processes the received fifth sensing signal. The control device 140 generates a fifth control signal according to the received fifth sensing signal, wherein the fifth control signal may be regarded as a steering control signal for having the intelligent walker 100 turn left. The fifth sensing signal is transmitted to the driving device 150. The driving device 150 drives the intelligent walker 100 to turn left according to the received fifth control signal. For example, when the driving device 150 receives the fifth sensing signal, the driving device 150 correspondingly controls the right wheels of the intelligent walker 100 to rotate faster than the left wheels of the intelligent walker 100 so as to cause the intelligent walker 100 to turn left.

On the other hand, when the force put on the pressure-sensing element 131 by the user's right hand is greater than the force put on the pressure-sensing element 131 by the user's left hand, the control device 140 receives a sixth sensing signal from the pressure-sensing element 131 and processes the received sixth sensing signal. The control device 140 generates a sixth control signal according to the received sixth sensing signal, wherein the sixth control signal may be regarded as a steering control signal for having the intelligent walker 100 turn right. The sixth sensing signal is transmitted to the driving device 150. The driving device 150 drives the intelligent walker 100 to turn right according to the received sixth control signal. For example, when the driving device 150 receives the sixth sensing signal, the driving device 150 correspondingly controls the left wheels of the intelligent walker 100 to rotate faster than the right wheels of the intelligent walker 100 so as to cause the intelligent walker 100 to turn right.

In the instant embodiment, when the force put on the pressure-sensing element 131 by the user's left hand is greater than the force put on the pressure-sensing element 131 by the user's right hand, the control device 140 generates the corresponding control signal for making the intelligent walker 100 turn right. On the other hand, when the force put on the pressure-sensing element 131 by the user's right hand is greater than the force put on the pressure-sensing element 131 by the user's left hand, the control device 140 generates the corresponding control signal for making the intelligent walker 100 turn left. The implementation and operation of the intelligent walker 100 and the present disclosure is not limited thereto.

In short, the user can straightforwardly control the intelligent walker 100 to turn left or turn right by changing the difference in force between the user's right hand and the user's left hand.

In the instant embodiment, please refer to FIG. 2C, which shows a schematic diagram of a sensing grip in accordance with another exemplary embodiment of the present disclosure. The pressure-sensing element 131 may be a single component, and the pressure-sensing element 131 disposed on the sensing grip 130 is configured for sensing the force put on the pressure-sensing element and the position of the user's hands on the pressure-sensing element, so that the user can control the operation of the intelligent walker 100. Similar operations of the intelligent walker 100 for the instant embodiment and the embodiments in FIGS. 1A to 2B are not repeated herein.

Please refer to FIG. 2D, which shows a schematic diagram of a sensing grip in accordance with another exemplary embodiment of the present disclosure. The pressure-sensing element 131 shown in the FIG. 2D includes a plurality of sensing regions R which are respectively located at the front and the back of the sensing grip 130. The sensing regions R are used for generating a plurality of sensing signals according to the force put on the pressure-sensing element 131, so that the control device 140 correspondingly determines whether the force put on the sensing grip 130 is push or pull according to the received sensing signals. More specifically, the sensing regions R may be divided by at least two areas. The at least two areas are used for respectively sensing the state of the force from the user's palm and the user's fingers when the user holds the sensing grip 130, so that the control device 140 can determine whether the intelligent walker 100 is pulled or pushed by the user. Accordingly, the control device 140 can control the intelligent walker 100 to move forwards or backwards according to the sensing signals from the sensing regions R.

In the instant embodiment, please refer to FIG. 2A and FIG. 2B, when the first indicated region (e.g. areas FD1 and FD2) or the second indicated region (e.g. areas SD1 and SD2) senses different direction of forces by the user's hands, the control device 140 controls the intelligent walker 100 correspondingly to turn left or turn right according to the sensing result of the pressure-sensing element 131. For example, when the area FD1 senses a pushing forward force from the user and the area SD2 senses a pulling backward force from the user, the intelligent walker 100 turns left. On the other hand, when the area FD2 senses a pulling forward force from the user and the area SD1 senses a pushing backward force from the user, the intelligent walker 100 turns right.

Please refer to FIG. 2E, which shows a schematic diagram of a pressure-sensing element being unloaded in accordance with an exemplary embodiment of the present disclosure. It is worth noting that the pressure-sensing element 131 is fixed on the outside surface of the sensing grip 130 through at least one Velcro. The least one Velcro is attached on the elastic fabric of the pressure-sensing element 131, so that the user can manually unload the old pressure-sensing element 131 and disposes the new pressure-sensing element 131 on the outside surface of the sensing grip 130.

In short, the intelligent walker 100 senses the direction and position of the force put on the sensing grip 130 through the pressure-sensing element 131, and the control device 140 regulates the movement direction and speed of the intelligent walker 100 according to the direction and position of the force put on the sensing grip 130 sensed by the pressure-sensing element 131. The user can straightforwardly control the rotational direction of the wheels 121 by putting different direction of forces on the different areas of the pressure-sensing element 131 so as to cause the intelligent walker 100 to turn left or turn right. Similar operations of the intelligent walker 100 for the instant embodiment and the embodiments in FIGS. 1A to 2B are not repeated herein.

In the instant embodiment, the instant embodiment differs from the embodiment in FIG. 1A in that the intelligent walker 100 further includes a safety lock device (not shown). The safety lock device is electrically connected to the control device 140 and the driving device 150, and configured for receiving a locking control signal transmitted by the control device 140 and locking the intelligent walker 100 so as to stop the movement of the intelligent walker 100 according to the received locking control signal, wherein the safety lock device may be a clutch module. For example, due to some external factors, the user's hands may be forced to leave the sensing grip 130 and stop putting force on the sensing grip 130. Correspondingly, the control device 140 transmits the locking control signal to the safety lock device when the control device 140 doesn't receive any sensing signal from the pressure-sensing element 131. According to the received locking control signal, the safety lock device locks the intelligent walker 100 to stop the movement of the intelligent walker 100. In this way, the intelligent walker 100 provided in the present disclosure may avoid danger when the user's hands are forced to leave the sensing grip 130 due to some external factors. For another example, the user straightforwardly pulls the sensing grip 130 backwards due to some obstacles on the road. Accordingly, if the magnitude of the pulling backward force exceeds a predetermined value, the control device 140 transmits the locking control signal to the safety lock device. According to the received locking control signal, the safety lock device stops the movement of the intelligent walker so as to avoid danger.

In the instant embodiment, the sensing grip 130 may be two independent grips, and each grip is disposed with a pressure-sensing element 131 for a user holding it to control the operation of the intelligent walker 100. Similar operations of the intelligent walker 100 for the instant embodiment and the embodiments in FIGS. 1A to 2B are not repeated herein.

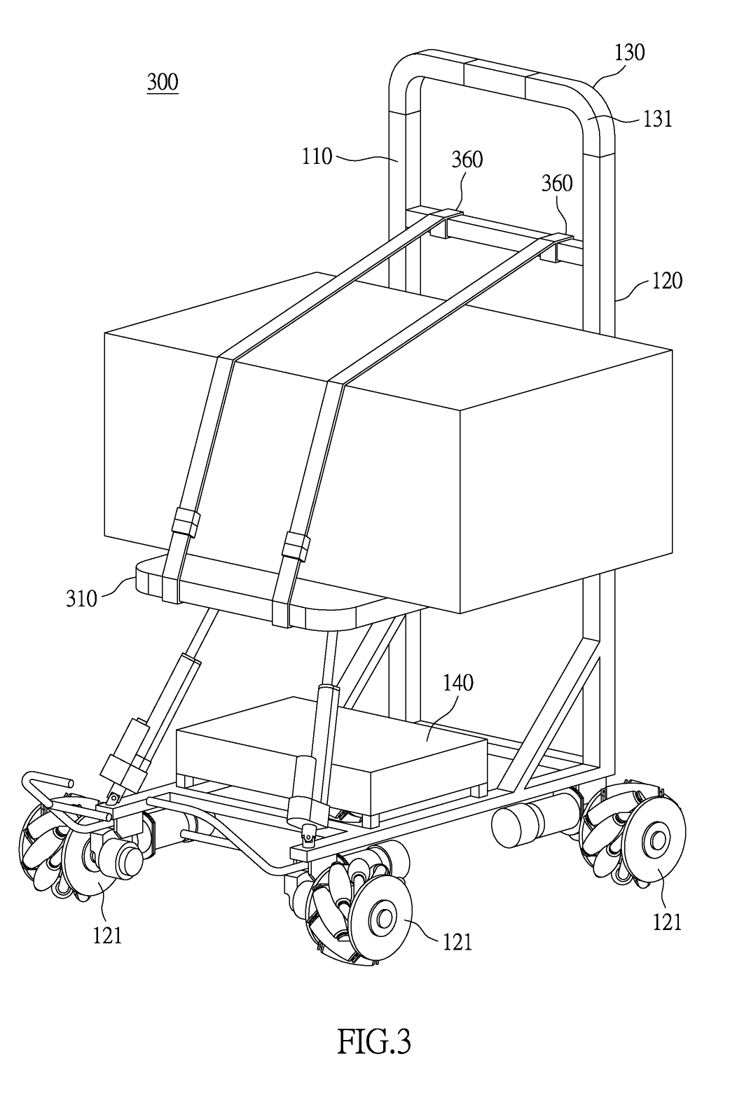

In the instant embodiment, the holder 110 may be a seat, a platform, or a box shaped for supporting a person or goods. The actual structure of the holder 110 may be configured depend upon the practical operation needs, and the instant embodiment is not limited thereto. Please refer to FIG. 3, which shows a schematic diagram of an intelligent walker in accordance with another exemplary embodiment of the present disclosure. As shown in FIG. 3, the instant embodiment differs from the embodiment in FIG. 1A in that the holder 310 of the intelligent walker 300 is a platform for supporting or bearing different goods, so that the user can transport heavy or large goods to a specified location through the intelligent walker 300. The type of the goods supported on the holder 310 may be configured depend upon the practical operation needs, and the instant embodiment is not limited thereto. In addition, the intelligent walker 300 further includes a plurality of adjustable straps 360, and the adjustable straps 360 are provided to the user for fixing the goods on the holder 310 so as to avoid the hazard of falling goods. Similar operations of the intelligent walker 300 for the instant embodiment and the embodiments in FIGS. 1A to 2B are not repeated herein. It is worth noting that the shape of the holder 310 may be configured depending upon the practical operation needs, such as a box shaped for supporting or bearing different goods.

In summary, exemplary embodiments of the present disclosure provide an intelligent walker with the sensing grip. The pressure-sensing element of the sensing grip is used for sensing the force put on the sensing grip and the position of the user's hands on the sensing grip, and generating the sensing signal. The control device correspondingly controls the driving device and regulates the movement speed and movement direction of the intelligent walker according to the received sensing signal. Accordingly, the way of operation of the intelligent walker is quite straightforward for the user.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A intelligent walker, comprising:
a holder;
a support frame, configured for supporting the holder, wherein the bottom side of the support frame is disposed with a plurality of wheels;
a driving device, configured for driving the wheels so as to move the intelligent walker;
a sensing grip, disposed behind the holder and having a pressure-sensing element, wherein the pressure-sensing element is configured for sensing a force put on the pressure-sensing element by a user's hands and a position of the user's hands on the pressure-sensing element, and generating a sensing signal; and
a control device, connected to the pressure-sensing element and the driving device, and configured for receiving the sensing signal and generating a control signal, wherein the control signal is transmitted to the driving device, and the driving device drives the wheels according to the control signal received so as to change the movement speed and movement direction of the intelligent walker.

2. The intelligent walker according to claim 1, wherein when the force becomes greater, the movement speed of the intelligent walker correspondingly becomes faster.

3. The intelligent walker according to claim 1, wherein when the force becomes smaller, the movement speed of the intelligent walker correspondingly becomes slower.

4. The intelligent walker according to claim 1, wherein when the force of the user's right hand is greater than the force of the user's left hand or the force of the user's left hand is greater than the force of the user's right hand, the intelligent walker correspondingly turns left.

5. The intelligent walker according to claim 1, wherein when the force of the user's right hand is greater than the force of the user's left hand or the force of the user's left hand is greater than the force of the user's right hand, the intelligent walker correspondingly turns right.

6. The intelligent walker according to claim 1, wherein when the user's hands hold a first indicated region of the pressure-sensing element, the intelligent walker correspondingly moves forwards.

7. The intelligent walker according to claim 1, wherein when the user's hands hold a second indicated region of the pressure-sensing element, the intelligent walker correspondingly moves backwards.

8. The intelligent walker according to claim 1, further comprising:
a safety lock device, electrically connected to the control device and the driving device, and configured for receiving a locking control signal transmitted by the control device and locking the intelligent walker so as to stop the movement of the intelligent walker according to the locking control signal received.

9. The intelligent walker according to claim 8, wherein when the user stops putting the force on the pressure-sensing element, the control unit transmits the locking control signal to the safety lock device, so that the safety lock device locks the intelligent walker to stop the movement of the intelligent walker.

10. The intelligent walker according to claim 8, wherein when the magnitude of the force exceeds a predetermined value, the control device transmits the locking control signal to the safety lock device, so that the safety lock device locks the intelligent walker to stop the movement of the intelligent walker.
